(19) United States
(12) Patent Application Publication
(10) Pub. No.: US 2015/0339450 A1
(43) Pub. Date: Nov. 26, 2015

(54) MEDICAL TECHNOLOGY FACILITY WITH OPTION FOR ENTERING PATIENT DATA AND INFORMATION

(71) Applicant: Siemens Aktiengesellschaft, Muenchen (DE)

(72) Inventors: Simon Allen-Raffl, Erlangen (DE); Aaron Flammang, Tustin, CA (US); Jens Guehring, Erlangen (DE); Stephan Nufer, Erlangen (DE); Alexandra Zahn, Buckenhof (DE)

(73) Assignee: Siemens Aktiengesellschaft, Muenchen (DE)

(21) Appl. No.: 14/718,373

(22) Filed: May 21, 2015

(30) Foreign Application Priority Data
May 21, 2014 (DE) 102014209649.9

(51) Int. Cl. G06F 19/00

(52) U.S. Cl. CPC G06F 19/3406

(57) ABSTRACT

In a method for operating a medical technology facility with a medical technology device for examining and/or treating a patient, wherein the medical device has a control console for making settings to the medical device throughput of examined and/or treated patients is improved by providing an input interface designed to be operated remotely from the control console. Through this input interface patient data are acquired for the patient and through a central coordination device of the system, the acquired patient data are received from the input interface and transmitted to the control console. Through the control console, the patient data are then displayed and/or settings are made to the medical device as a function of the patient data.

### BACKGROUND OF THE INVENTION

1. Field of the Invention

The invention relates to a method for operating a medical technology facility with a medical technology device, for example a computed tomography (CT) or a magnetic resonance tomography (MRT) apparatus. The medical device has a control console for making device settings. The invention also concerns a medical technology facility that is able to be operated with such a method.

2. Description of the Prior Art

When patients are examined or treated with an examination device of a specific medical technology modality, for example MR, CT or ultrasound, the same issue always arises at the outset in the view of the operator of such a medical technology examination system, namely to be sure of the patient's identification and further examination-specific patient data. As soon as a patient appears for his or her appointment at the examination system, the patient must therefore be prepared for the examination. A person carrying out the examination, for example the doctor or an MTRA (medical technology radiology assistant) has a preliminary discussion with the patient for this purpose. This discussion involves asking about exclusion criteria, known as contraindications, and patient attributes for the examination, such as, for example, whether there are metal objects in the patient's body or how much the patient currently weighs and whether the patient has known allergies. Furthermore an outline of the examination or treatment sequence is given, so that, for example, the patient can subsequently cooperate better with breathing commands and can be better attuned to them. The patient data captured in the preliminary discussion is validated with patient data that has been supplied via an RIS (Radiology Information System) and/or an HIS (Hospital Information System). It may be that further corrections and validations are undertaken here on paper or at the control console. Therefore, the preliminary discussion must be carried out at the control console for the examination device, so that the expanded and/or corrected patient data is available right away for the impending examination.

### SUMMARY OF THE INVENTION

An object of the invention is to increase the throughput of examined and/or treated patients in a medical technology facility.

In accordance with the invention, a medical technology facility is provided for examination and/or treatment of a patient in the manner described at the start, wherein the system has a medical technology device, such as a CT or MR scanner or an ultrasound applicator, with a control console for making device settings. In accordance with the invention the system additionally has an input interface designed to be operated at a different location from the control console that is designed for entry of the patient data. Furthermore, a central coordination computer is provided that is designed to receive the entered patient data from the input interface and to transfer the received patient data to the control console. During operation of the inventive system the inventive method described below is carried out.

Via the input interface provided in the inventive system, the examination-specific and/or treatment-specific patient data are acquired from the patient, and such data are now acquired at a location remote from the control console and at a different time. Through the central coordination device, for example a central processor device operated in the system, such as a central server computer for example, the patient data acquired are received from the input interface and later, i.e. when required, when the patient is to be examined and/or treated by the medical device, or the patient is located at and/or in the medical device, are transmitted to the control console. Through the control console the patient data are then displayed and/or medical device settings are made as a function of the patient data.

The invention has the advantage that the data relevant for the examination or treatment is visible at the control console and the operator can thus adjust and react to the daily plan better. Device-specific parameters can also be retrieved at the coordination device and adapted to the patient before the actual examination. Due to the input interface and the coordination device the patient data can be acquired at a separate location from the control console and thus from the medical technology device. During the acquisition of the patient data the device itself can thus be used for examination and/or treatment of another patient. The patient's time in the medical technology facility, for example a medical practice or department of a hospital, for example a radiological department, can thus be divided, namely into the preliminary phase, during which a preliminary discussion is conducted, and an actual examination and/or treatment phase, during which the medical device is used. By providing the input interface and the central coordination device (computer) the preliminary phase with the patient can now be carried out at a different location, for example in a separate consulting room or at a reception desk, while the medical device is still being used for the examination and/or treatment of another patient.

In an embodiment of the invention, at least one tablet PC is provided as the input interface. The patient data in this case is preferably transferred via a radio link to the coordination device. In other words the input hardware of the input interface is able to be operated as mobile device is portable so that the patient data can be acquired by an MTRA in the especially flexible manner, such as at a freely selectable location in the system. For example, patient data can be displayed on the Tablet PC and the MTRA can ask the patient if the displayed data are correct.

In a further embodiment, an examination and/or treatment enquiry relating to the patient is received by the coordination device from an RIS and/or an HIS. This enquiry can be an appointment date for the examination and/or treatment. At the appointed time, the presence of the patient is then monitored at a prespecified time interval, for example at an interval of ten minutes to two hours before the planned examination/treatment, and if the patient is present an enquiry request is output to initiate the acquisition of the patient data via the input interface. For presence monitoring, a check can be made, for example, as to whether at a reception point of the system, where an assistant receives patients arriving and notes that they are present, a database entry signaling the presence is available. If the patient is present, an enquiry request is output to the input interface by the coordination device for initiating the acquisition of the patient data, i.e. to instigate the preliminary discussion. This enquiry request signals to that person operating or using the input interface that they should now ask the patient about the patient data. Through this the sequence is controlled centrally in the system by the coordination device.

In another form of embodiment, completeness of the available patient data of the patient is checked by the coordination device before the data acquisition. If missing patient data are detected, a request signal relating to the missing patient is output via the input interface. Through this request, the attention of the person who is operating the input interface is then drawn to the fact that specific patient data is still missing and must be requested from the patient, in order that the examination and/or treatment can be carried out. If, for example, an RIS or an HIS signals that the patient is to be given an MRT examination, then on checking of the completeness it can be established whether it is known whether the patient has metal objects in his or her body. If no data are stored for this question, then there can be an output via the input interface, as a note about questions to ask, that the patient is to be asked questions relating to metal objects in his or her body. This form of embodiment has the particular advantage that no patient data relevant to the examination are forgotten with the result that the patient is brought to the medical device without all patient data being complete.

A further advantage is achieved in an embodiment wherein discussion or information data are transmitted by the coordination device for output at the input interface. Such information data relate in such cases especially to the medical device itself, for example its dimensions and the space available for the patient during the examination and/or treatment. This has the particular advantage that the patient is made aware of any possible spatial restrictions and can therefore ask the special treatment because of claustrophobia. The information data can also contain breathing instructions for the patient, so that the patient is prepared the examination and/or treatment in the medical device, which guarantees a smooth execution of the examination and/or treatment. Audio recordings of noises of the medical device can also be contained in the information data, which can then be played via the input interface so that the patient is prepared for possible noises such as, for example, knocking of an MRT device and the patient is not alarmed during the examination. Information data can be provided as text and/or graphics and/or video data and/or audio data.

A particular advantage is produced if designations are read from the medical device by the coordination device of available operating protocols, i.e. examination protocols or treatment protocols. Such operating protocols define how the medical device is to work or to be operated while the patient is located via and/or in the medical device. These designations are then output at the input interface, so that a person operating the input interface can see which operating protocols are available in the medical device. Via the input interface a selection of the operating protocols is then received by the coordination device and the selected operating protocol is set at the medical device. This produces the particular advantage that a person, e.g. an MTRA, who finds out by the input interface on entering the patient data which examination and/or treatment is to be carried out on the patient, now has an overview of which appropriate operating protocols are available for this. This person can then select the appropriate operating protocol, so that it is then set automatically at the medical device as soon as the patient is at and/or in the medical device. Therefore an operator working at the control console does not have to ask the patient once again which examination and/or treatment is to be undertaken, so that the appropriate operating protocol is only looked for at the control console.

A further advantage is produced if the acquired patient data are sent by the coordination device to an RIS and/or an HIS as expanded and/or corrected patient data for storage. This means the current patient data are then also available in the RIS and/or HIS.

Preferably after acquisition of the patient data, a synchronization signal is sent to the control console and/or to an RIS and/or to an HIS by the coordination device. This synchronization signal signals the presence of changed patient data. The advantage of this is that the use of out-of-date and/or incorrect patient data is avoided. As soon as up-to-date patient data is known, the synchronization signal avoids out-of-date patient data being accidentally used in the system as a whole and also in the RIS and/or HIS.

### BRIEF DESCRIPTION OF THE DRAWINGS

FIG. 1 shows a schematic diagram of a form of embodiment of the inventive medical technology facility.

FIG. 2 shows a schematic diagram of an embodiment of the inventive input interface with a display relating to the patient present in the system.

FIG. 3 shows the input interface of FIG. 2 with a display relating to available operating protocols of a medical device of the system.

### DESCRIPTION OF THE PREFERRED EMBODIMENTS

The exemplary embodiment explained below involves a preferred form of embodiment of the invention. However in the exemplary embodiment the described components of the form of embodiment each represent individual features of the invention to be considered separately from one another, which in each case also develop the invention separately from one another and thus are also to be viewed as a component of the invention individually or in a combination other than the one shown. Furthermore the described form of embodiment is also able to be expanded by further of the features already described of the invention.

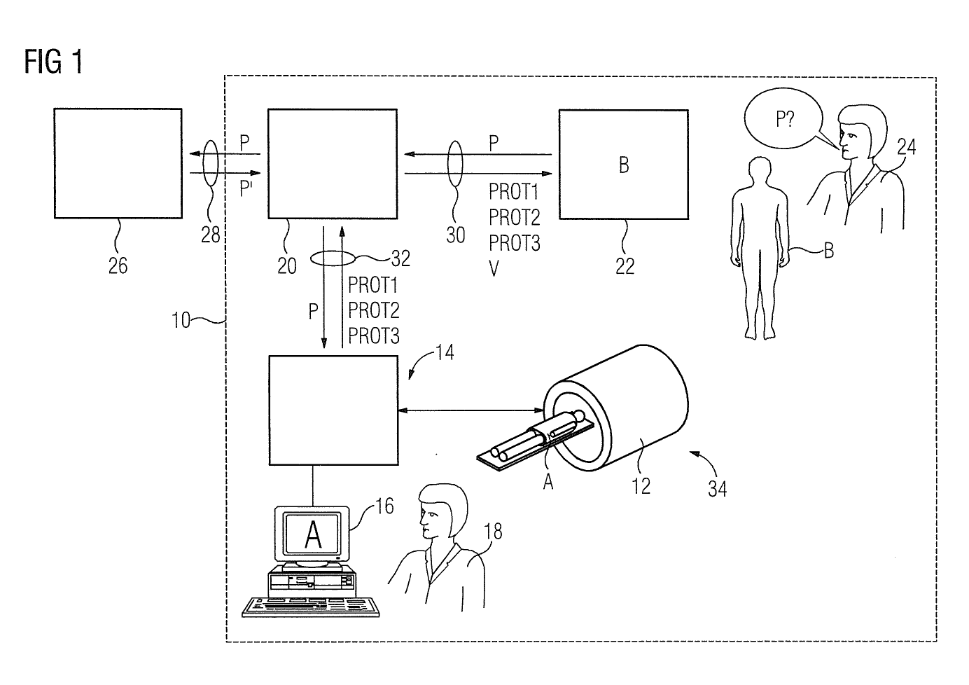

FIG. 1 shows a medical technology facility 10, which can be set up for example in a medical practice or in a hospital. The system 10 can feature a medical technology device 12, for example a computed tomography scanner or a magnetic resonance tomography scanner or an ultrasound applicator or a radiation source for radiation therapy. The medical device 12 can be operated or set or controlled by a control console 14 with a control terminal 16. The control console 14 can be operated by an assistant 18, e.g. an MTRA. The system can further have a central coordination device 20 and an input interface 22. The input interface 22 can be operated by a further assistant 24. The coordination device 20 can be coupled to an RIS and/or HIS 26 via a communication network 28 for example. The coordination device 20 can be provided, for example, as a central computer. The input interface 22 can be one or more portable tablet PCs for example. The input interface 22 can be coupled to the coordination device 20 via a communication link 30, for example a radio link such as a WLAN radio link (WLAN—Wireless Local Area Network). The coordination device 20 can also be coupled via a communication link 32 to the control console 14.

With the system 10 it is insured that the medical device 12 achieves a high throughput of patients. In the example shown the two assistants 18, 24 divide up the work equally, but offset in time. The assistant 24 is already clarifying points with a patient B in a preliminary discussion and is acquiring patient data P to be validated. During this time the assistant 18 is already undertaking an examination and/or treatment of a patient A by means of the medical device 12. As soon as the patient A is finished, the patient B can enter a medical device room 34 in which the medical device 12 is located and the examination and/or treatment of the patient B can begin without delay. The assistant 18 receives the patient data P established by the assistant 24 via the control console 14 and has the patient data displayed on the terminal 16. They can now set the medical device 12 in accordance with the patient data P and/or as per requirements which are displayed by the patient data. There can also be provision for the medical device 12 to be set by the control console on the basis of the patient data P without the involvement of the assistant 18.

The assistant 24 has entered the patient data P into the input interface 22, from where the patient data has been transmitted by the communication link 30 to the coordination device 20, which has transmitted the patient data P at the beginning of the examination and/or treatment of the patient B to the control console 14.

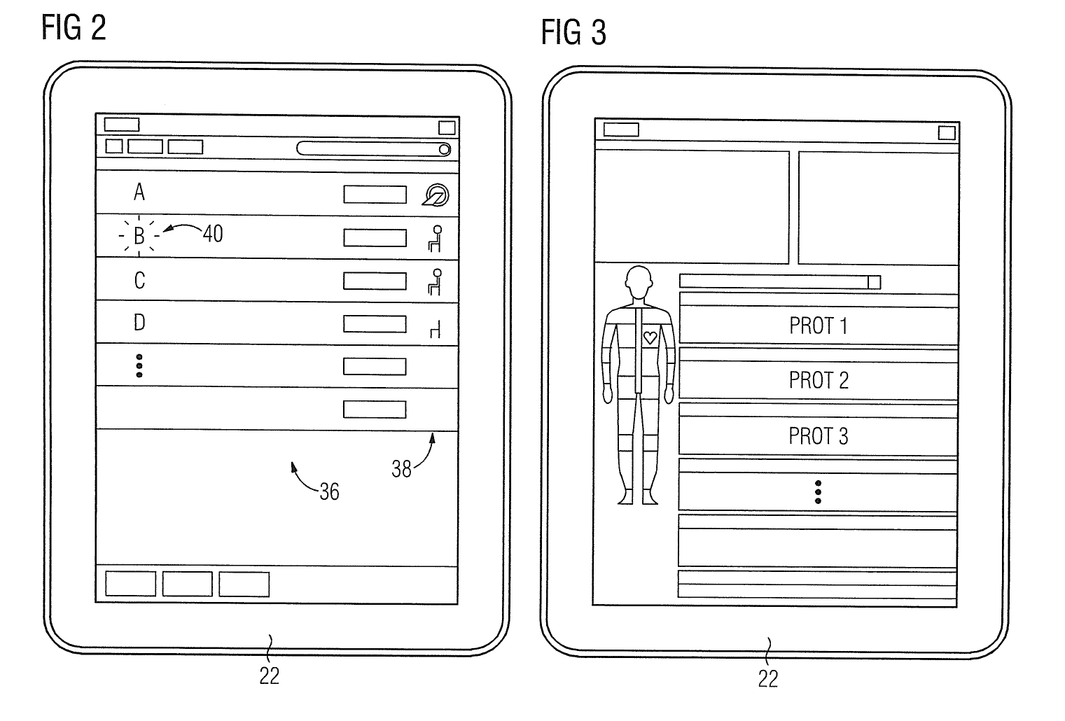

Which patient the assistant 24 must question can also be displayed to the assistant 24 via the input interface 22. To this end FIG. 2 illustrates how, via the input interface 22 of the assistant 24, a list 36 of the patients A, B, C, D to be expected for a specific period of time, for example during one day, and further patients symbolized by omission points ( . . . ) can be shown. For example the assistant 24 is shown by symbols 38 that the patient A is currently located for examination and/or treatment in the medical device 12. The patients B and C are located in a waiting room and are ready for a preliminary discussion. The patient D has not yet arrived. It is also indicated to the assistant 24, for example optically, for example by flashing 40, that the patient B is the next to be asked about their patient data P since they are the next patient who is to be examined and/or treated by means of the medical device 12. Accordingly the assistant 24 has selected the patient B for a preliminary discussion. The preliminary discussion no longer has to be necessarily conducted at the control console 14 and therefore allows a more efficient utilization of the medical device 12.

During the preliminary discussion the assistant 24 can establish for example that the operating protocol for the examination and/or treatment of the patient B is still to be defined at the medical device 12. There can be provision here for the coordination device 20 to read out the protocols PROT 1, PROT 2, PROT 3 available in the medical device 12, via the control console 14 and the communication link 32 for example, and to transfer via the communication link 30 the protocol designation PROT 1, PROT 2 and PROT 3 to the input interface 22 where, as illustrated in FIG. 3, it can be displayed to the assistant 24. The assistant 24 can then select an appropriate protocol and the selected protocol is then transmitted as a component of the patient data P to the coordination device 20 again.

Information data, for example video data V, can also be transmitted to the input interface 22 by the coordination device 20, so that the assistant 24 using the input interface 22 has information available that they can show to the patient B just interviewed so that the patient is better prepared for his or her time in the device room 34.

There can now be provision that, as soon as the patient B enters the room 34 for examination and/or treatment and goes into or to the medical device 12, the selected protocol is selected at the control console 14 by the coordination device 20 via the communication link 32.

Through the preliminary discussion the assistant 24 establishes for example the following patient data: Which patient is involved (patient identification)? Is the patient ambulant or stationary? Are contraindications present for the examination/treatment, for example in relation to a contrast medium to be injected? Does the patient need special consideration because of their mobility, for example because they are in a wheelchair? When is the patient being given their examination? How long does the examination last? Are all relevant data present?

There can already be previous patient data P′ for this purpose from the RIS and/or HIS 26 which can likewise be received from the coordination device 20, wherein this patient data P′ can contain a request relating to the required examination and/or treatment. In relation to the patient data if necessary an agreement declaration must be retrieved and/or an intravenous drip applied and possibly laboratory values present tested. In addition it must also be defined how the patient, seen relative to the medical device, must be positioned, for example lying on their back or head first.

The patient data P′ already supplied via the RIS/HIS 26 (for example name, identification number, weight, examination required) is validated with the patient data P requested in the preliminary discussion and if necessary corrected at the input interface 22. If the patient data P′ is not available or not complete for the required examination, the assistant 24 can register the patient manually by means of the input interface 22. Since all the patient data P needed in the patient preparation is now available on one system, namely the coordination device 20, and can be edited, corrected and expanded directly during the preliminary discussion with the patient by means of the input interface 22, true added value is produced for the operator of the system 10. The working step of the preliminary discussion at the control console 14 of the medical device 12 and the interaction with the various data-maintenance systems is dispensed with. The coordination device 20 can make the current patient data available at any time both to the control console 14 and also to the RIS/HIS 26. This means greater data quality, i.e. greater safety for the patient and a general time-saving in operation of the system 10.

If namely for patient B for example all patient data P has already been acquired, corrected, expanded, validated and stored centrally in the coordination device 20 in the preparation outside the room 34 by means of the mobile input interface 22, the patient B then only has to be selected at the control console 14 before the examination and the examination can be started directly. This enables the utilization of the medical device 12 to be increased.

At the heart of the invention is thus the central coordination device 20, which can coordinate and edit the patient data P from different systems, namely the input interface 22, the control console 14 and the RIS/HIS 26. The coordination device 20 can be accessible for example from several devices, such as the control console 14, the mobile terminals of the input interface 22 and/or further consoles, for example at a reception area of the system 10 or at a desk. The coordination device 20 functions as a server and constantly updates its database, so that newly-entered, deleted or revised patient data P is always up-to-date on all connected devices/consoles. For this purpose, if the patient data P is modified, a corresponding synchronization signal can be sent out to the connected devices so that said devices prepare themselves for receiving the new patient data.

Each device/console connected to the coordination device 20 can access the data record with the patient data P and process such data. After the processing the dataset is synchronized with all connected devices. At the coordination device 20 it must then be noted for the processed data record that the record has been processed, so that in an automatic updating of the coordination device 20 it is not overwritten by the data emanating from various systems, so that it can be seen that the data state has been processed. If for example an assistant has postponed an appointment by a half an hour then the planned examination time no longer matches the planned examination time in another system.

In the context of the patient preparation discussion tablet PCs with different operating systems and/or platforms can be used as acquisition device 22 for mobile acquisition of the patient data, wherein the communication link 30 can be provided for example by means of WLAN and the HTTP protocol (HTTP Hypertext Transfer Protocol).

In user feedback of a test with test subjects it has been shown that the option of retrieving, editing and validating patient data in the mobile context gives real added value in the working organization of radiology or generally in a system so that, through this, the medical device 12 of the system achieves a higher throughput of patients. If the system is organized by means of the coordination device 20, the pre-examination workflow, i.e. the preliminary discussion before the actual examination and/or treatment of the patient can be divided up better between the operating personnel of the system 10, especially the assistants 18, 24, which leads to higher efficiency of the workflow. It is also conceivable that a person in reception, when receiving a patient, retrieves the data record with the patient data and validates the patient data and corrects it if necessary.

The use of the input interface by the assistants 18, 24 can be carried out in a helper/scanner scenario or in an A/B scenario.

In the helper/scanner scenario the assistant 24 providing the help takes over the preparation of the patient, requests the patient information and attributes to be validated, meaning the patient data, and documents this by means of the input interface 22. Previously stored patient data P′ can also be reconciled and corrected if necessary. The corrected patient data P are then received by the coordination device 20 and if necessary transmitted to the control console 14.

In the A/B scenario the assistants 18, 24 swap roles whenever a patient is finished at the medical device 12, so that the assistant 24, who has conducted the preliminary discussion with the patient B now also looks after the patient B during their time in and/or at the medical device 12. The assistant 24 then also operates the control console 14.

Overall the example shows how a pre-examination can be carried out by the invention for radiology independently of the location of the examination device.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for operating a medical technology facility comprising a medical technology device for at least one of examination or treatment of a patient, said medical technology device comprising a control computer console via which settings are entered into said medical technology device, said method comprising:
providing an input interface for said control computer console that is situated remote from said control computer console;
via said input interface, acquiring patient data for a patient to be examined or treated at said medical technology device;
transmitting the acquired patient data from the input interface to a central coordination computer, and thereafter transmitting the acquired patient data from the central coordination computer to said control computer console; and
at said control computer console, displaying displayed information selected from the group consisting of said patient data and settings of said medical technology device that are a function of said patient data.

2. A method as claimed in claim 1 comprising employing a tablet PC as said input interface, and transmitting said patient data wirelessly from said tablet PC to said central coordination computer.

3. A method as claimed in claim 1 comprising providing a request for examination or treatment of said patient, including an appointment of the patient to the central coordination computer from a computerized information source, and, from said central coordination computer, at a time of said appointment, monitoring a predetermined location for presence of the patient at said location at predetermined intervals and, when said patient is present at said location, causing an interview request to be emitted via said input interface that initiates the acquisition of said patient data.

4. A method as claimed in claim 1 comprising, in said central coordination computer, evaluating said patient data to determine whether said patient data are complete and, if any patient data are determined at said central coordination computer to be missing, emitting an instruction to supply the missing patient data from the central coordination computer to said input interface.

5. A method as claimed in claim 1 comprising, in said central coordination computer, generating informational data dependent on said examination or treatment of said patient, said informational data comprising at least of an identification of said medical technology device, breathing instructions for the patient during said examination or treatment, an audio recordings of noises made by said medical technology device during said examination or treatment, and transmitting said informational data to said input interface and displaying said informational data at said input interface.

6. A method as claimed in claim 1 comprising, from said central coordination computer, reading out designations of available operating protocols from said medical technology device and causing said designations of available operating protocols to be displayed at said input interface and, via said input interface selecting one of said operating protocols as a setting for operation of said medical technology device to implement said examination or treatment of said patient.

7. A method as claimed in claim 1 comprising, from said central coordination computer, transferring the acquired patient data to a hospital information system for storage in said hospital information system.

8. A method as claimed in claim 1 comprising, at said central coordination computer, determining an occurrence of modification of said patient data and, when said occurrence is detected, transmitting a synchronization signal at least to said control computer console that synchronizes the patient data at said control computer console with the modified patient data.

9. A method as claimed in claim 1 comprising treating or examining a different patient at said medical technology device while said patient data for said patient are being acquired at said input interface.

10. A medical technology facility comprising:
a medical technology device for at least one of examination or treatment of a patient, said medical technology device comprising a control computer console via which settings are entered into said medical technology device;
a central coordination computer;
an input interface for said control computer console that is situated remote from said control computer console;
said input interface being configured to acquire patient data for a patient to be examined or treated at said medical technology device;
said input interface being configured to transmit the acquired patient data from the input interface to said central coordination computer, and said central coordination computer being configured to transmit the acquired patient data from the central coordination computer to said control computer console; and
said control computer console being configured to display displayed information selected from the group consisting of said patient data and settings of said medical technology device that are a function of said patient data.
